(19) United States
(12) Patent Application Publication
(10) Pub. No.: US 2004/0215922 A1
(43) Pub. Date: Oct. 28, 2004

(54) Efficient addressing method and apparatus for storage

(76) Inventors: J. Barry Shackleford, Portola Valley, CA (US); Motoo Tanaka, Tokyo (JP)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/423,773

(22) Filed: Apr. 24, 2003

(51) Int. Cl. G06F 12/00

(52) U.S. Cl. 711/219; 711/205

(57) ABSTRACT

A method and apparatus is used select a multiplication constant for addressing a storage location with reduced processing requirements. The selection includes receiving a multiplication constant for use in an arithmetic operation to address a storage location, determining an upper limit multiplication constant compared with the received multiplication constant, counting the number of zero digits for each binary value contained in the range of binary values greater than the multiplication constant value and less than or equal to the upper limit multiplication constant and selecting the binary value from the range having the greatest number of zero digits as the modified multiplication constant.

### BACKGROUND OF THE INVENTION

The present invention relates to the efficiently addressing storage on computers and systems.

A variety of applications or hardware systems store data elements in look-up-tables (LUT) and storage areas to be retrieved subsequently during data processing. An address associated with each data element in the storage area is used to access the portion of the storage area having the particular data element being requested for further processing. If the data elements can be arranged as a list of elements then a simple one-dimensional (1D) array can be used to store each element and the corresponding address for gaining access to the element of data. Further, if the number of elements being stored is a power of 2 (i.e., 2¹, 2², 2³, 2⁴, . . . , 2ⁿ) then the number of elements will fit into the LUT or storage area allocated for addressing the data elements without fragments or wasted storage. For example, a storage area having 512K (512 times 1024 bytes) of addressable capacity can efficiently store and address 512K data elements. Fewer than 512K data elements would leave portions of the storage area empty and waste the storage capacity.

Moreover, many systems need to store a number of data elements not measured evenly by a power of 2. Typically, systems used to analyze complex biological and non-computer based binary systems store a number of data elements not measured by a power of 2. For example, a storage area used to store 19 different amino acids for analysis would occupy less than 32 storage areas and greater than 16 storage areas. In a binary system, 32 storage areas would be allocated but approximately 40% of the storage would not be addressed or used. Implementing hardware systems with unused memory increases overall costs yet is not required to operate the system. In general, addressing larger amounts of memory than required by the LUT also impacts system cost and performance by increasing the size of the digital system beyond what is necessary.

In some cases, the data elements are logically organized as multidimensional tables rather than 1D array as described above. Applications accessing database tables of information grouped into multiple different categories may use the abstraction of a multidimensional array to make accessing data elements more efficient and intuitive. For example, an application used to analyze triplets of 19 different amino acids would store the different combination of amino acids in a multidimensional array with one dimension for each of the 19 different amino acids. Conventional binary storage would require a binary array having 32×32×32 or 32,768 storage units even though only 19×19×19 or 6,859 would be required.

Many hardware implementations use 1D arrays to store lists of 1D data elements as well as multidimensional arrays of information. The 1D array can accommodate many different size multidimensional arrays and is often easier to implement in hardware. Different addressing methods are used to map the data elements stored in the multidimensional array with the data element at the corresponding offset in the 1D array. Often, the multiplication constants used to convert between the multidimensional array and the 1D array may take many processing cycles or be implemented by large amounts of hardware logic. Unfortunately, the design time and processing required to convert between the address space in the multidimensional array and the 1D array can be time consuming and expensive to compute. For example, the 6859 elements from a 19×19×19 multidimensional array may appear scattered throughout the 32768 storage units of a 1D array used to hold and address the values. The existing conventional approaches for storing data elements not addressed by a power of 2 do not effectively address the wasted space and hardware implementation costs.

### BRIEF DESCRIPTION OF THE DRAWINGS

FIG. 1 is a block diagram and table associated with a conventional look-up-table (LUT) and implementation in hardware;

FIG. 2A is a block diagram of a LUT for addressing a 9-element LUT more effectively;

FIG. 2B is a schematic diagram of the hardware for addressing a 9-element LUT more effectively;

FIG. 3 provides a series of diagrams illustrating the conversion between a 3-dimensional LUT and the 1-dimensional array implemented in hardware;

FIG. 4 depicts a modified multiplication constant in accordance with one implementation of the present invention for performing a multiplication;

FIG. 5 is a flowchart diagram depicting the operations associated with implementations of the present invention to select a modified multiplication constant value;

FIG. 6 provides operations for selecting a modified multiplication constant to address the 1D array in real-time given an original multiplication constant value; and

FIG. 7 is a block diagram depicting one genetic algorithm circuit capable of using one implementation of the present invention in a fitness function portion of the GA circuit.

Like reference numbers and designations in the various drawings indicate like elements.

### SUMMARY OF THE INVENTION

One aspect of the present invention describes selecting a multiplication constant for addressing a storage location with reduced processing requirements. The selection includes receiving a multiplication constant for use in an arithmetic operation to address a storage location, determining an upper limit multiplication constant compared with the received multiplication constant, counting the number of zero digits for each binary value contained in the range of binary values greater than the multiplication constant value and less than or equal to the upper limit multiplication constant and selecting the binary value from the range having the greatest number of zero digits as the modified multiplication constant.

Another aspect of the present invention describes addressing a multiple dimension storage area. This addressing aspect of the present invention includes identifying a modified multiplication constant having a greater number of zero values in binary representation than an initial multiplication constant value when represented in binary, and wherein the modified multiplication constant is a larger value than the initial multiplication constant value and multiplying the modified multiplication constant and an index value from the multiple dimension storage area to facilitate determination of an address for storing a value in a single dimension storage area.

### DETAILED DESCRIPTION

Aspects of the present invention are advantageous in at least one or more of the following ways. Implementations of the present invention simplify arithmetic calculations and reduce hardware design requirements for addressing memory or storage areas. Multiplication constant values modified in accordance with the present invention require fewer carry-add operations when calculating address locations in storage. With fewer carry-adders, multiplication operations are performed with fewer logic elements when implemented in hardware. While the modified multiplication constant values may imply using a somewhat larger address space, the incremental cost for the larger memory is far outweighed by the reduced costs for the fewer logic elements.

Further aspects of the present invention can be used advantageously to implement multidimensional storage areas and LUTs in hardware. A 1D array uses modified multiplication constants of the present invention to convert between an address in the multidimensional logical LUT and an address in the one dimensional array for storing the data. Once again, the modified multiplication constants identified in accordance with the present invention reduce both the complexity and cost of implementing LUTs in hardware as fewer carry-adder circuits are required. Genetic algorithm (GA) analysis, color management methods, and any other data processing using LUTs and addressing schemes in accordance with the present invention will benefit from the reduced computational complexity and implementation costs.

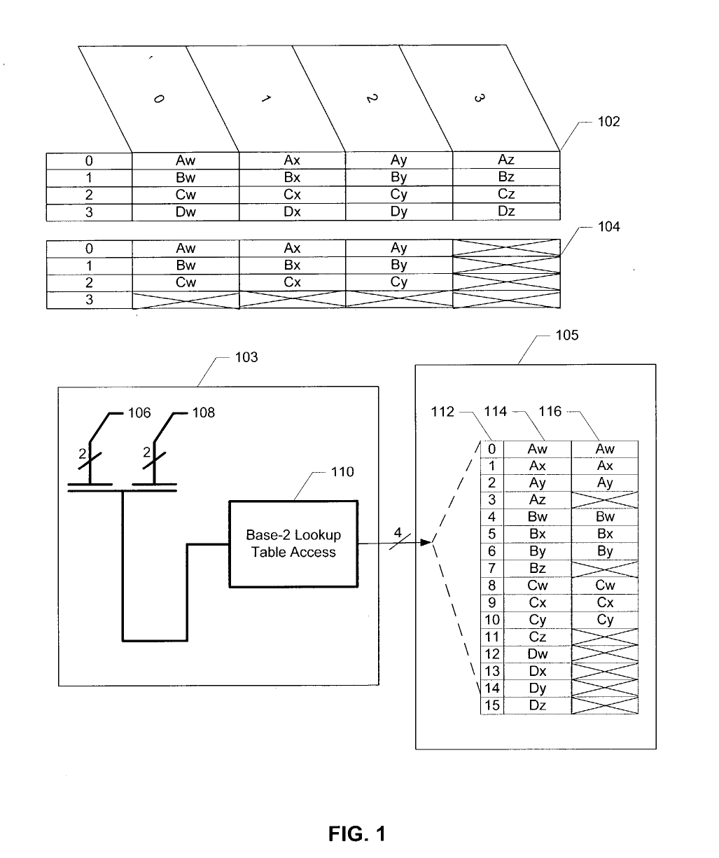

FIG. 1 depicts block diagrams and tables associated with a conventional look-up-table as implemented in hardware. This diagram illustrates a 16-element LUT 102, a 9-element LUT 104, address logic 103 and a one-dimensional (1D) memory 105 for storing the LUT values in hardware. Each of the elements in both 16-element LUT 102 and 9-element LUT 104 can be referenced logically by specifying a row and column position in the respective logical LUT. Every row and column address pair reference different elements in 16-element LUT 102. In contrast, only some of the row and column entries in 9-element LUT 104 reference data elements as fewer elements are being stored. For example, row 3 and column 3 reference element “Dz” in 16-element LUT 102 while the same row 3 and column 3 in 9-element LUT 104 does not reference an element value. Memory fragments or unused memory in the 9-element LUT 104 occurs because the number of elements in 9-element LUT 102 is not a power-of-two.

Address logic 103 maps elements in the multidimensional tables into a 1D memory 105. 1D memory 105 can be configured to work with different length 1D array and implemented with different addressing schemes to accommodate different size multidimensional tables. Accordingly, it is more effective to implement the multidimensional array using a 1D array in hardware. In this example, a row index 106 and a column index 108 are concatenated together using base-2 lookup table access 110 to directly access different portions of 1D memory 105.

In 1D memory 105, 1D array 114 is used to store 16-element LUT 102 while 1D array 116 stores 9-element LUT 104. There is a one-to-one correspondence between each of the 16 address entries in index 112 and the elements in 1D array 114 but not with each entry in 1D array 116 as it only includes 9-elements. Unused elements in 1D array 116 become unused memory fragments as the underlying 9-element LUT 102 is not a power of 2. In this example, entries 3, 7, 11, 12, 13, 14 and 15 are not used to store data from 9-element 1D array 116 yet continue to take up valuable storage.

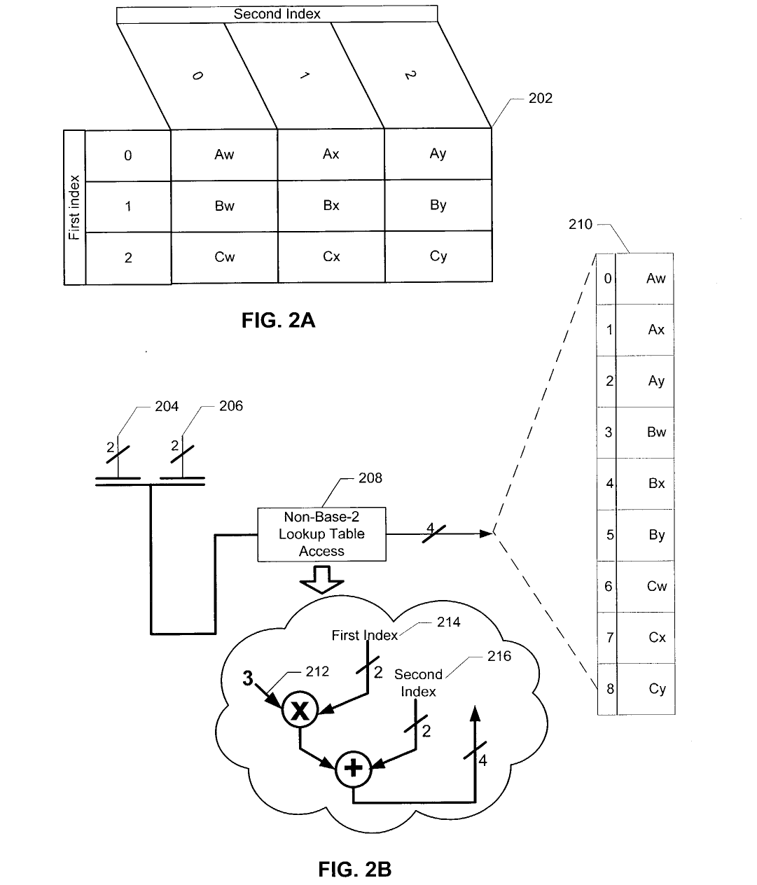

A different scheme of addressing is used to reduce the amount of unused memory fragments when the number of elements being stored is not a power of 2. This addressing scheme generates a multiplication constant corresponding to one or more dimensions of the multidimensional LUT. The resulting multiplication constant is combined with an element value in the LUT. FIG. 2A is a block diagram of a LUT and FIG. 2B includes schematic drawings of the hardware for addressing a 9-element LUT 202 more effectively than previously described. Here, 9 elements are stored in a smaller 9-element LUT 202 rather than the larger 16-element LUT. Both row index 204 and column index 206 are provided to a non-base-2 lookup table access 208 to address the proper entry in a 1D array 210. No memory fragments are created as each element of the 1D array is filled with a value from the 9-element LUT.

Non-base-2 lookup table access 208 facilitates addressing 1D array 210 by way of a multiplication constant 212, a first index 214 and a second index 216. Multiplication constant 212, set to the value “3” in this example, is multiplied by first index 214 and added to second index 216 to address the proper entry in 1D array 210. For example, the address in 1D array 210 for element “Cx” is generated by multiplying the multiplication constant “3” by first index value “2” and adding the corresponding second index value ”1” resulting in address “7” in 1D array 210.

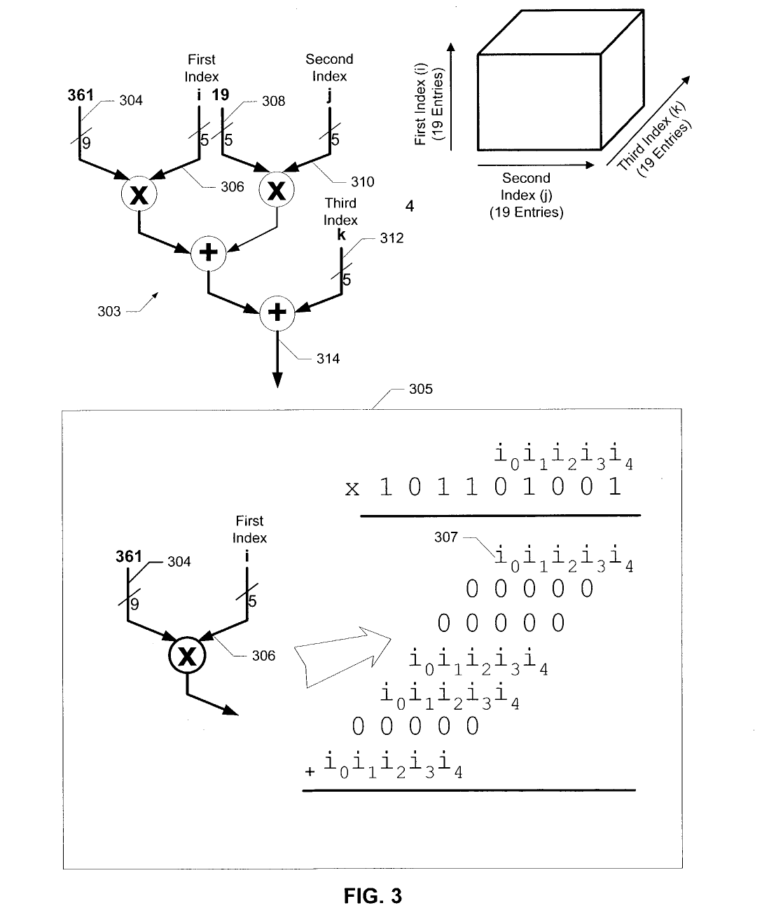

FIG. 3 provides a series of diagrams illustrating the address conversion between a 3-dimensional LUT and the 1-dimensional array implemented in hardware. The diagrams in FIG. 3 include a three-dimensional table 302, a non-base-2 lookup table access 303 for three-dimensions and the implementation details 305 for one portion of the arithmetic calculation.

In this example, three-dimensional table 302 has indices i=19, j=19, and k=19 representing triplets of amino acids to be stored in a LUT. These amino acid combinations could be used in genetic algorithm (GA) analysis as entries in the LUT for a fitness function. Here, non-base-2 lookup table access 303 facilitates accessing a 1D memory using a first multiplication constant 304, a first index 306, a second multiplication constant 308, a second index 310, and a third index 312. First multiplication constant 304 and second multiplication constant 308 correspond to 19² (i.e., 19×19=361) and 19¹ values. In operation, the value associated with the first index 306 is multiplied by a multiplication constant input 304 and then added to the value associated with the third index 312. Similarly, the value in second index 310 is multiplied against second multiplication constant 308 and then added into the overall equation.

Implementation details 305 illustrate the arithmetic operations associated with first multiplication constant 304 and first index 306. This arithmetic operation implemented in hardware requires a bitwise multiplication of the binary value of “101101001” (i.e., 361) and 5-bit value associated with first index 306 represented as i₀i₁i₂i₃i₄. In hardware, this would require the processing of 25 variable bit-terms requiring underlying hardware logic. For example, i₀i₁i₂i₃i₄ is a sequence of 5 variable bit-terms while a multiplication constant like “101101001” has five one-bit terms and 7 zero-bit terms). The five one-bit terms in the multiplication constant incur more processing as the multiplication results depend on values in one or more of the variable bit-elements in i₀i₁i₂i₃i₄; the 7 zero bit-terms do not have the same result as multiplying any value times 0 has a predetermined result (i.e., 0). Consequently, while use of first multiplication constant 304 helps reduce the memory fragments and wasted memory, it also requires an increased amount of hardware to perform the calculations.

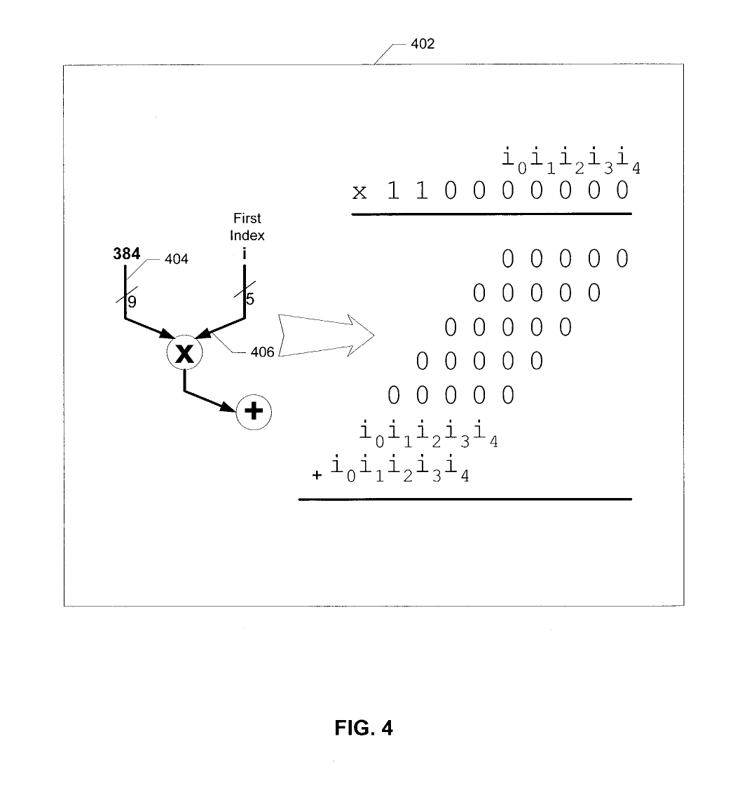

To improve the efficiency of performing this calculation in hardware, implementations of the present invention generate a modified multiplication constant. FIG. 4 depicts a modified multiplication constant in accordance with one implementation of the present invention for performing a multiplication. Implementations of the present invention use a multiplication constant with fewer one bit-terms (“1” values) and more zero bit-terms (“0” values) in the binary representation. This reduces the amount of required hardware as the zero bit-terms in the modified multiplication constant do not require the same amount of hardware when multiplied with variable bit-terms like i₀i₁i₂i₃i₄. In the present example, implementation detail 402 provides a modified multiplication constant 404 having a pair of consecutive one bit-terms or “1” values in the binary multiplication constant (i.e., binary value “110000000”) rather than five one bit-terms as the previous example used.

Many optimizations can be performed using modified multiplication constant 404 of the present invention compared with previously described approaches. With fewer “1” values and more “0” values in modified multiplication constant 404, for example, the partial multiplications will result in “00000” values or zero bit-terms so much less hardware is required. Instead, results from multiplication operations using zero bit-terms can be handled by directly providing zero values to various registers. Alternatively, a slower implementation would shift zeros into the various register for calculations instead. In the present example, only the last two partial multiplications require full hardware support and cannot be determined in advance. Hardware is simplified and costs are reduced by carefully selecting multiplication constant value 404 in accordance with implementations of the present invention and requiring the processing of the one bit-terms.

Generally, the larger address and memory space required when using modified multiplication constant 404 is outweighed by the reduced design and implementation costs associated with the simplified logic of the present invention. For example, the approach outlined in FIG. 3 used multiplication constant 304 having binary value “101101001” (i.e., 361). Multiplication constant 304 implies addressing a smaller range of memory addresses than modified multiplication constant 404 of the present invention using binary value “1100000000” (i.e., 384). Yet, implementations of the present invention using modified multiplication constant 404 still remain more cost effective as the costs associated with increased memory and address requirements are far outweighed by the cost savings to not implement logic for the additional carry bit adders and the like.

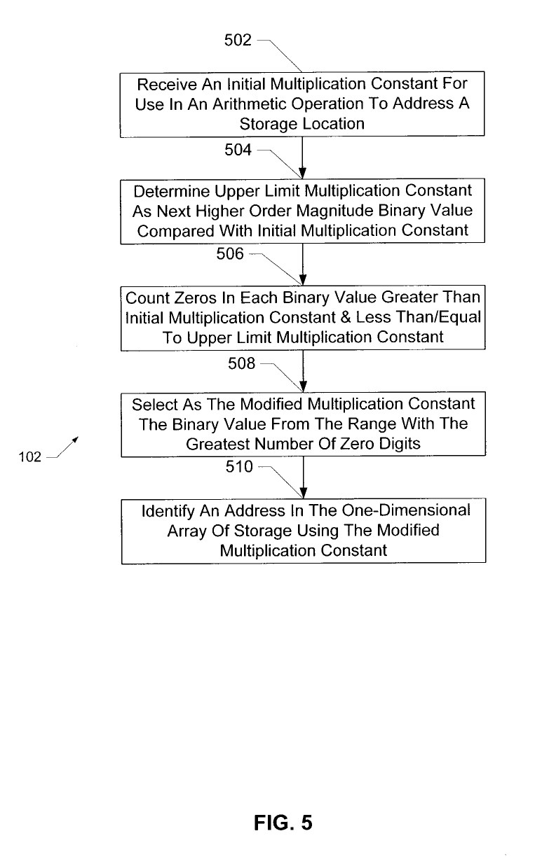

FIG. 5 is a flowchart diagram depicting the operations associated with implementations of the present invention to select a modified multiplication constant value. Initially, an initial multiplication constant value is provided to be used in an arithmetic operation for addressing a storage location (502). The initial multiplication constant generally corresponds to one dimension of a LUT and is not an even power of two. As previously described, setting the initial multiplication constant value to one dimension of the LUT is more effective than using the next higher power of two for the address space. For example, setting an initial multiplication constant to binary value “101101001” (i.e., 361 or 19²) for a 19×19×19 LUT has a smaller address space requirement than the much larger power of two binary value “1000000000” (i.e., 512 or 2⁹).

Next, implementations of the present invention set an upper limit multiplication constant as a next higher order magnitude binary value compared with the initial multiplication constant (504). This upper limit multiplication constant provides an upper limit on the range of values when searching for the modified multiplication constant. For example, binary value “1000000000” (i.e., 512) can be set as the upper limit when the initial multiplication constant provided is binary value “101101001” (i.e., 361). Accordingly, the search for the modified multiplication constant would consider binary values ranging from “101101001” (i.e., “361”) to “1000000000” (i.e., “512”). Of course, alternate implementations could search a smaller predetermined offset from the initial multiplication constant value to further limit the range of values being considered. Using this latter approach, the search could be limited to the range of binary values from “101101001” to “101111111” or from 361 to 383.

For each binary value, implementations of the present invention count the zeros in each binary value and perform a comparison with the initial multiplication constant. In one implementation, the number of zeros should be greater than the zeros in the initial multiplication constant and less than/equal to upper limit multiplication constant (506). For example, if the initial multiplication constant is “101101001” then a modified multiplication constant of “111000000” having 5 zeros rather than only 4 zeros would be a candidate. Alternatively, implementations of the present invention could set a threshold level of zeros to search for in the range and discard other values. Setting the threshold for the number of zeros in the modified multiplication constant to 5 zeros would consider only those binary values having 5 or more zeros and would discard all other values. As applied to the instant example, “110000001” (i.e., “385”) would be considered yet “111000011” (i.e., “451”) would not as the latter binary value has only 4 zeros and does not meet the threshold criteria.

In one implementation of the present invention, the multiplication constant having the greatest number of zero digits is selected from the multiplication constant's being considered as the modified multiplication constant (508). As previously described, the modified multiplication constant having a greater number of zero digits requires less hardware logic to implement. As yet another alternate implementation, the criteria for selecting a multiplication constant may not only require a minimum number of zeros in the binary representation but also have a maximum value to reduce the address space requirement. This latter approach to selecting the modified multiplication constant would strike a balance between reducing the logic required for implementation as well as reducing the address space requirements for storing values in the 1D array. In either approach, the modified multiplication constant selected in accordance with the present invention is then used to address storage in the 1D array (510).

In the implementation previously described, the modified multiplication constant is selected in advance and fixed in the hardware used to calculate an address in the 1D array. However, an alternate implementation selects the modified multiplication constant on demand in real-time rather than in advance; this could be used to make implementations of the present invention downward compatible with legacy systems using less efficient memory and LUT addressing methods.

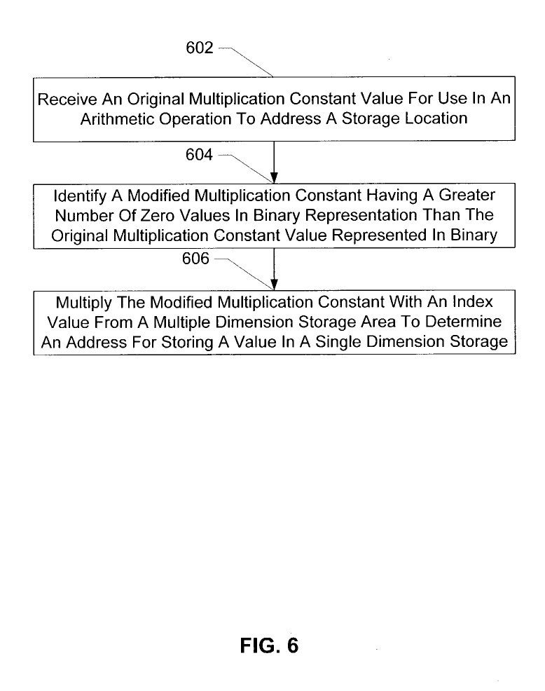

Accordingly, FIG. 6 provides operations for selecting the modified multiplication constant to address the 1D array in real-time given an initial multiplication constant value. This implementation of the present invention receives an original multiplication constant value for use in an arithmetic operation to address a storage location (602). As previously described, the initial multiplication constant value represented as a binary value has a number of “1” values requiring additional carry adders and logic circuitry while the present invention operates with less such requirements.

Next, the present invention identifies a modified multiplication constant having a greater number of zero values in binary representation than the original multiplication constant in binary (604). Essentially, one or more operations described and depicted in association with FIG. 5 are performed to identify and select the modified multiplication constant. The resulting modified multiplication constant is then used to identify an address in the 1D array of storage (606). It should be appreciated that one or more modified multiplication constants can be selected in accordance with the present invention depending on the type of addressing arithmetic performed. For example, translating the addresses from a large multidimensional LUT may utilize multiple modified multiplication constants selected in accordance with the present invention and having some correspondence to the number of dimensions in the multidimensional LUT.

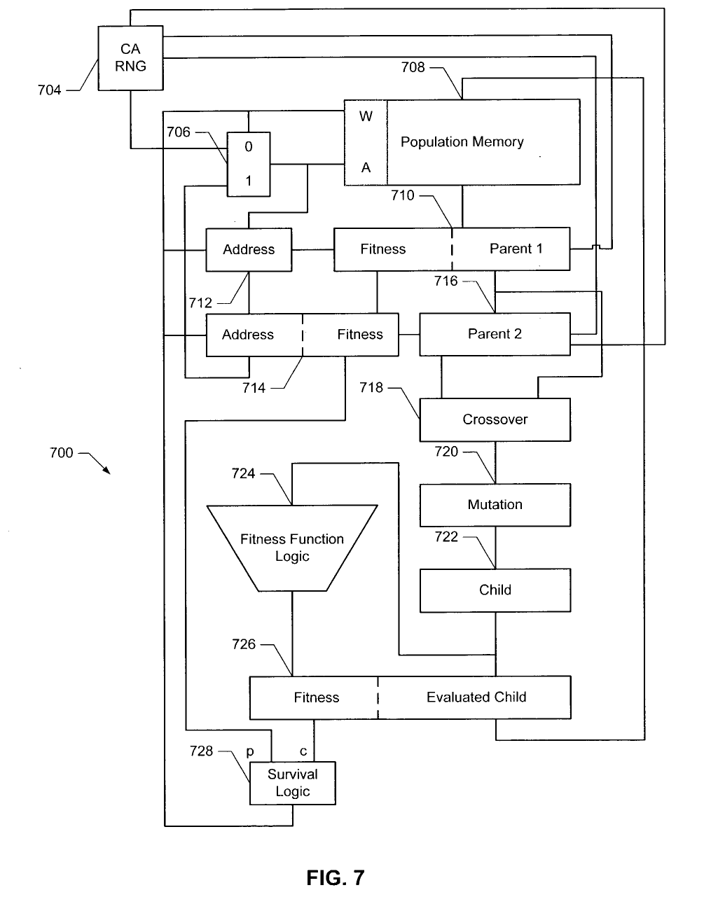

Applications of the present invention can be used to improve the hardware implementation and performance of many different systems and designs. Specifically, implementations of the present invention can reduce the memory requirements for storing a LUT or data values while eliminating logic area required for addressing the storage. For example, genetic algorithm (GA) circuits used for solving complex computational problems can benefit from implementations of the present invention. Accordingly, FIG. 7 is a block diagram depicting one genetic algorithm circuit capable of using one implementation of the present invention in a fitness function portion of the GA circuit. GA circuit 700 includes a cellular automata random number generator (CA RNG) 704, a population memory MUX 706, a population memory 708, a parent 1 and fitness register 710, a parent 1 address register 712, a parent 2 address and fitness register 714, a parent 2 register 716, crossover logic 718, mutation logic 720, child register 722, fitness function logic 724, evaluated child and fitness register 726, and survival logic 728.

During initialization mode, CA RNG 704 produces random numbers used for a variety of purposes in the GA circuitry including loading population memory 708 with the population chromosomes. Implementations of the present invention can be used to select appropriate multiplication constants used in addressing LUTs in fitness function 724.

Crossover logic 718 combines the parent 1 and parent 2 values in a probabilistic manner. Mutation of the resulting combination between parent 1 and parent 2 occurs, if at all, in mutation logic 720 and then is stored in child register 722 for further processing.

Each new child chromosome in child register 722 is also provided with a fitness value. Fitness function logic 724 processes the child chromosome stored in child register 722 according to the predetermined evaluation criteria to create the initial fitness value. This fitness value for the child chromosome is stored along with the child chromosome in evaluated child and fitness register 726 awaiting further processing/evaluation. The child fitness value in evaluated child and fitness register 726 is compared with the corresponding fitness of the lesser fit parent in population memory 703 using survival logic 728. To locate the lesser fit parent more readily, the address of the lesser fit parent can be stored in a lesser-fit register. If the child chromosome has a better fitness than the lesser fit parent, it replaces the lesser fit parent and is stored at the lesser fit parent's address in population memory 708. Over time, the random numbers stored in population memory 708 evolve into an optimal solution in accordance with the GA analysis process.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of selecting a multiplication constant for addressing a storage location with reduced processing requirements, comprising:
receiving a multiplication constant for use in an arithmetic operation to address a storage location;
determining an upper limit multiplication constant compared with the received multiplication constant;
counting the number of zero digits for each binary value contained in the range of binary values greater than the multiplication constant value and less than or equal to the upper limit multiplication constant; and
selecting the binary value from the range having the greatest number of zero digits as the modified multiplication constant.

2. The method of claim 1 further comprising:
correlating an address in a one dimensional array of storage to a higher dimension array using the modified multiplication constant.

3. The method of claim 1 wherein the multiplication constant received corresponds to at least one dimension from a multi-dimensional array and is not an even power-of-two.

4. The method of claim 1 wherein the storage location and address corresponds to a look-up table (LUT) as used in genetic algorithm (GA) computations.

5. The method of claim 1 wherein the storage location and address corresponds to a look-up table (LUT) used in conjunction with storing and accessing color related information by a color management module.

6. The method of claim 1 wherein the upper limit multiplication constant is determined as a next higher order of magnitude binary value compared with the received multiplication constant.

7. The method of claim 1 wherein the upper limit multiplication constant is determined as a predetermined offset from the received multiplication constant value to further limit the range of values being considered.

8. The method of claim 1 wherein selecting the binary value further includes considering only multiplication constant's having a minimum number of zero values in the binary representation.

9. The method of claim 1 wherein selecting the binary value further includes considering only those multiplication constants having a minimum number of zero values in their binary representation and a maximum value to reduce the address space requirement.

10. The method of claim 1 wherein selecting the binary value as the modified multiplication constant also considers the number of contiguous zero digits in addition to the total number of zero digits in the binary representation.

11. A method of addressing a multiple dimension storage area, comprising:
identifying a modified multiplication constant having a greater number of zero values in binary representation than an initial multiplication constant value when represented in binary, and wherein the modified multiplication constant is a larger value than the initial multiplication constant value; and
multiplying the modified multiplication constant and an index value from the multiple dimension storage area to facilitate determination of an address for storing a value in a single dimension storage area.

12. The method of claim 11 further comprising combining two or more modified multiplication constants and indices to facilitate determination of the address for storing a value in the single dimension storage area.

13. The method of claim 11 wherein multiplying the modified multiplication constant and the index value in binary requires less hardware to implement in proportion to the increased number of zero binary values in modified multiplication constant when compared with the number of zero binary values in the initial multiplication constant.

14. The method of claim 11 wherein identifying a modified multiplication constant occurs on demand and in real-time rather for downward compatible with a legacy storage system using less efficient addressing methods.

15. The method of claim 11 wherein the storage area and address corresponds to a look-up table (LUT) used in genetic algorithm (GA) computations.

16. A computer program product for selecting a multiplication constant for addressing a storage location with reduced processing requirements, tangibly stored on a computer-readable medium, comprising instructions operable to cause a programmable processor to:
receive a multiplication constant for use in an arithmetic operation to address a storage location;
determine an upper limit multiplication constant compared with the received multiplication constant;
count the number of zero digits for each binary value contained in the range of binary values greater than the multiplication constant value and less than or equal to the upper limit multiplication constant; and
select the binary value from the range having the greatest number of zero digits as the modified multiplication constant.

17. The computer program product of claim 16 further comprising:
correlating an address in a one dimensional array of storage to a higher dimension array using the modified multiplication constant.

18. The computer program product of claim 16 wherein the multiplication constant received corresponds to at least one dimension from a multi-dimensional array and is not an even power-of-two.

19. The computer program product of claim 16 wherein the storage location and address corresponds to a look-up table (LUT) used in genetic algorithm (GA) computations.

20. The computer program product of claim 16 wherein the storage location and address corresponds to a look-up table (LUT) used in conjunction with storing and accessing color related information by a color management module.

21. The computer program product of claim 16 wherein the upper limit multiplication constant is determined as a next higher order of magnitude binary value compared with the received multiplication constant.

22. The computer program product of claim 16 wherein the upper limit multiplication constant is determined as a predetermined offset from the received multiplication constant value to further limit the range of values being considered.

23. The computer program product of claim 16 wherein selecting the binary value further includes considering only multiplication constant's having a minimum number of zero values in the binary representation.

24. The computer program product of claim 16 wherein selecting the binary value further includes considering only those multiplication constants having a minimum number of zero values in their binary representation and a maximum value to reduce the address space requirement.

25. The computer program product of claim 16 wherein selecting the binary value as the modified multiplication constant also considers the number of contiguous zero digits in addition to the total number of zero digits in the binary representation.

26. A computer program product for addressing a multiple dimension storage area, tangibly stored on a computer-readable medium, comprising instructions operable to cause a programmable processor to:
identify a modified multiplication constant having a greater number of zero values in binary representation than an initial multiplication constant value when represented in binary, and wherein the modified multiplication constant is a larger value than the initial multiplication constant value; and
multiply the modified multiplication constant and an index value from the multiple dimension storage area to facilitate determination of an address for storing a value in a single dimension storage area.

27. The computer program product of claim 26 further comprising combining two or more modified multiplication constants and indices to facilitate determination of the address for storing a value in the single dimension storage area.

28. The computer program product of claim 26 wherein multiplying the modified multiplication constant and the index value in binary takes less hardware to implement in proportion to the increased number of zero binary values in modified multiplication constant when compared with the number of zero binary values in the initial multiplication constant value.

29. The computer program product of claim 26 wherein identifying a modified multiplication constant occurs on demand and in real-time rather for downward compatible with a legacy storage system using less efficient addressing methods.

30. An apparatus for selecting a multiplication constant for addressing a storage location with reduced processing requirements, comprising:
means for receiving a multiplication constant for use in an arithmetic operation to address a storage location;
means for determining an upper limit multiplication constant compared with the received multiplication constant;
means for counting the number of zero digits for each binary value contained in the range of binary values greater than the multiplication constant value and less than or equal to the upper limit multiplication constant; and
means for selecting the binary value from the range having the greatest number of zero digits as the modified multiplication constant.

31. An apparatus for addressing a multiple dimension storage area, comprising:
means for identifying a modified multiplication constant having a greater number of zero values in binary representation than an initial multiplication constant value when represented in binary, and wherein the modified multiplication constant is a larger value than the initial multiplication constant value; and
means for multiplying the modified multiplication constant and an index value from the multiple dimension storage area to facilitate determination of an address for storing a value in a single dimension storage area.

32. An apparatus for selecting a multiplication constant for addressing a storage location with reduced processing requirements, comprising:
a processor containing instructions when executed receive a multiplication constant for use in an arithmetic operation to address a storage location, determine an upper limit multiplication constant compared with the received multiplication constant, count the number of zero digits for each binary value contained in the range of binary values greater than the multiplication constant value and less than or equal to the upper limit multiplication constant, and select the binary value from the range having the greatest number of zero digits as the modified multiplication constant.

33. An apparatus for addressing a multiple dimension storage area, comprising:
a processor containing instructions when executed identify a modified multiplication constant having a greater number of zero values in binary representation than an initial multiplication constant value when represented in binary, and wherein the modified multiplication constant is a larger value than the initial multiplication constant value and multiply the modified multiplication constant and an index value from the multiple dimension storage area to facilitate determination of an address for storing a value in a single dimension storage area.
